(19) United States
(12) Patent Application Publication
(10) Pub. No.: US 2023/0034411 A1
(43) Pub. Date: Feb. 2, 2023

(54) Propane Digital Smart Device

(71) Applicant: Ernest Middleton, Spavinaw, OK (US)

(72) Inventor: Ernest Middleton, Spavinaw, OK (US)

(21) Appl. No.: 17/862,452

(22) Filed: Jul. 12, 2022

Related U.S. Application Data
(60) Provisional application No. 63/226,443, filed on Jul. 28, 2021.

(51) Int. Cl. F17C 13/02; G01L 19/08

(52) U.S. Cl. CPC F17C 13/025; G01L 19/086; F17C 2250/043; F17C 2221/035; F17C 2250/034; F17C 2250/0417; F17C 2250/0491

(57) ABSTRACT

The present invention relates to a remote propane-monitoring device primarily comprised of a body with a front surface further comprised of a display and at least one button, a retaining clip and a mobile application. In the preferred embodiment, the body is generally rectangular and is made from a rigid, water-resistant/water-proof, weather-resistant plastic. The body further has a clip assembly that allows the device to attach to a propane gauge of a propane tank and a piping/tubing that attaches to the tank. The device is further comprised of an internal pressure gauge that reads the pressure of the propane gas being pushed out from the tank to determine the level of propane gas left in the tank and relay said information to the mobile application.

### CROSS-REFERENCE TO RELATED APPLICATION

The present application claims priority to, and the benefit of, U.S. Provisional Application No. 63/226,443, which was filed on Jul. 28, 2021 and is incorporated herein by reference in its entirety.

### FIELD OF THE INVENTION

The present invention relates generally to the field of propane tanks. More specifically, the present invention relates to a remote propane monitoring device primarily comprised of a body with a front surface further comprised of a display and at least one button, an optional retaining clip and a mobile application. In the preferred embodiment, the body has a clip assembly that allows the device to attach to a propane gauge of a propane tank and a piping/tubing that attaches to the tank. The device is further comprised of an internal pressure gauge that reads the pressure of the propane gas being pushed out from the tank to determine the level of propane left in the tank and relay said information to the mobile application. Accordingly, the present disclosure makes specific reference thereto. Nonetheless, it is to be appreciated that aspects of the present invention are also equally applicable to other like applications, devices and methods of manufacture.

### BACKGROUND

Propane tanks of various sizes are used for providing fuel to heat homes and power appliances, such as but not limited to, space heaters, hot water heaters, generators, grills, etc. However, due to the extremely combustible nature of propane gas, a propane tank must be continually monitored to ensure they are functioning. Most propane tanks have a gauge that indicates the status of the propane in the tank. However, if a propane tank is left outside or is located outside, the gauge can become covered with dirt and debris, or become rusted or broken, such that the gauge becomes unreadable. In addition, a user must physically travel to the location of the propane tank to check the gauge. This is undesirable if the propane tank is in a hard-to-reach area or is located outside during extreme weather conditions. Furthermore, some individuals may be physically unable to travel to the location of the propane tank due to a physical disability or limited mobility. Finally, some users may desire to check the status of a propane tank located at a vacation home or hunting cabin, without having to be physically present at the location.

Therefore, there exists a long-felt need in the art for a device that allows a user to view the fuel status of a propane tank. There also exists a long-felt need in the art for a remote propane monitoring device that allows a user to view and monitor the fuel status of a propane tank, without having to be physically present at the propane tank. Finally, there exists a long-felt need in the art for a remote propane monitoring device that allows a user to view and monitor the status of multiple propane tanks at one time.

The subject matter disclosed and claimed herein, in one embodiment thereof, comprises a remote propane monitoring device. The device is primarily comprised of a body with a front surface further comprised of a display screen and at least one button, an optional retaining clip and a mobile application. In the preferred embodiment, the body is generally rectangular and is made from a rigid, water-resistant/waterproof and weather-resistant plastic. The body further has a clip assembly that allows the device to attach to a propane gauge of a propane tank and a piping/tubing that attaches to the tank. The device is further comprised of an internal pressure gauge that reads the pressure of propane gas being pushed out from the tank to determine the level of propane left in the tank, and relays said information to the mobile application.

In this manner, the remote propane-monitoring device of the present invention accomplishes all of the forgoing objectives and provides an improved means to monitor the fuel status of a propane tank. The device allows a user to view and monitor the fuel status of a propane tank without having to be physically present at the propane tank. Further, the device allows a user to view and monitor the status of multiple propane tanks at one time, using the mobile application. In this manner, the remote propane monitoring device overcomes the limitations of existing methods of monitoring the fuel status of propane tanks known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remote, propane-monitoring device. The device is primarily comprised of a body with a front surface further comprised of a display and at least one button, a retaining clip and a mobile application. In the preferred embodiment, the body is generally rectangular, and is made from a rigid, water-resistant/waterproof, weather resistant plastic. The at least one button may further have a plurality of indica on its top surface that indicates the function of the button. In the preferred embodiment of the device, there are at least 3 buttons, a first button that when pressed prompts the display to display the remaining fuel percentage of the tank, a second button that can be used to alert a propane supplier (who can be selected using the mobile application) that the tank needs to be refilled, and a third button that allows a use to pair the device to a smart device that has installed the mobile application. The display and all other components of the device are powered by an internal battery, that in one embodiment may be recharged using a USB port.

The device also has a clip assembly fixedly or removably-attached to the bottom surface of the body via a vertical member that extends away from the top of the clip body. In one embodiment, the clip assembly has a generally circular, continuous body with a continuous opening that allows the clip body to be slid onto the piping/tubing of a propane tank. This embodiment may also have at least one fastener and a two-piece, generally circular body that allows the body to increase or decrease in size (i.e., diameter) in order to universally attach to any piping/tubing.

In another embodiment, the interior of the clip body may have a plurality of male and/or female threads, such that it can attach to an existing threaded end of a propane gauge of a tank (i.e., wherein a piping/tubing would normally be connected to the threaded end) and the piping/tubing of a tank. In this manner, the clip attaches to both the piping and the pressure gauge, such that an internal pressure gauge of the device may read the pressure of propane gas being pushed out from the tank, to determine the level of propane gas left in the tank and relay said information to the mobile application.

The mobile application can be used on any smart device and presents the user with a visual representation of the propane tank to which the device is attached, and the fuel status of said tank (i.e., how much propane remains in the tank). In order to communicate with the mobile application, the device has an integrated transmitter that may communicate with the mobile application via Wi-Fi, Bluetooth, Satellite, Cellular Date, etc. The device is also comprised of a processor that communicates with the PSI reading from the pressure gauge and converts said reading into a percentage representative of the amount of propane remaining in the tank. This percentage is then communicated to the transmitter and is then sent to the mobile application for viewing in the form of the visual representation. The mobile application may also have at least one virtual representation of a button, that allows a user to access the same features provided by the physical buttons on the display.

Accordingly, the remote propane monitoring device of the present invention is particularly advantageous, as it allows a user to view and monitor the fuel status of a propane tank without having to be physically present at the propane tank. Further, the device allows a user to view and monitor the status of multiple propane tanks at one time, using the mobile application. In this manner, the remote propane monitoring device overcomes the limitations of existing methods of monitoring the fuel status of propane tanks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the remote propane monitoring device of the present invention disclosing the display screen and control buttons in accordance with the disclosed architecture;

FIG. 2 illustrates a perspective view of one potential embodiment of the remote propane monitoring device of the present invention while attached to a small propane tank in accordance with the disclosed architecture;

FIG. 3 illustrates a perspective view of one potential embodiment of the remote propane monitoring device of the present invention while attached to a large propane tank in accordance with the disclosed architecture;

FIG. 4 illustrates a perspective view of one potential embodiment of the remote propane monitoring device of the present invention communicating with a mobile application on a smart device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a user to view the fuel status of a propane tank. There also exists a long-felt need in the art for a remote propane-monitoring device that allows a user to view and monitor the fuel status of a propane tank without having to be physically present at the propane tank. Finally, there exists a long-felt need in the art for a remote propane-monitoring device that allows a user to view and monitor the status of multiple propane tanks at one time.

The present invention, in one exemplary embodiment, is comprised of a remote propane-monitoring device primarily comprised of a body with a front surface further comprised of a display and at least one button, a retaining clip and a mobile application. In the preferred embodiment, the body is generally rectangular and is made from a rigid, water-resistant/waterproof, weather-resistant plastic. The body further has a clip assembly that allows the device to attach to a propane gauge of a propane tank and a piping/tubing that attaches to the tank. The device is further comprised of an internal pressure gauge that reads the pressure of the propane gas being pushed out from the tank to determine the level of propane gas left in the tank and relay said information to the mobile application.

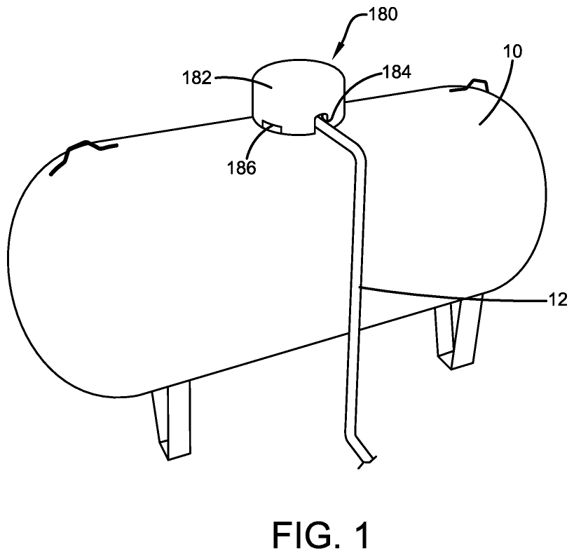

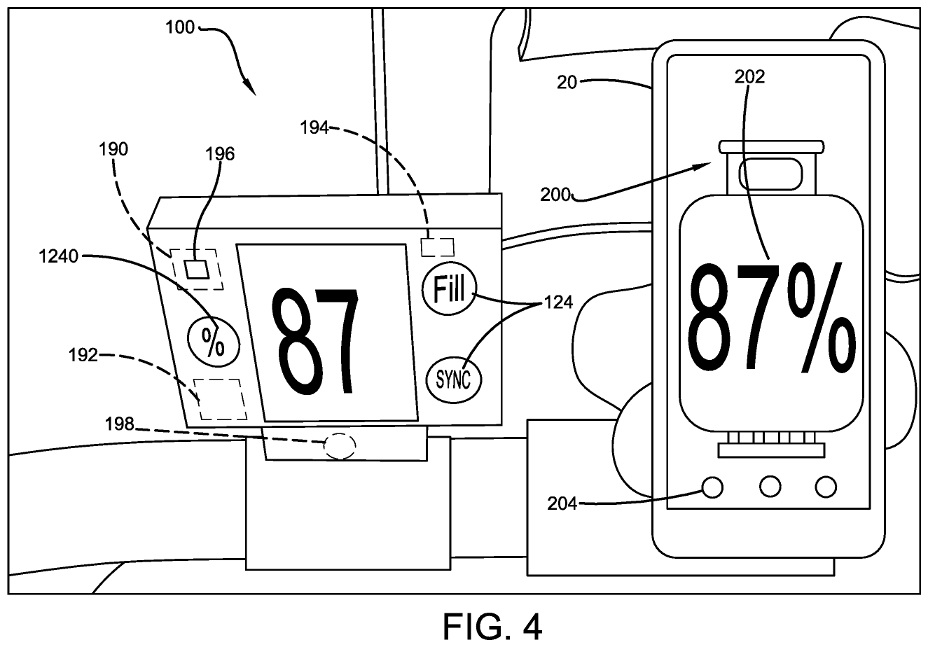

Referring initially to the drawings, FIG. 1 illustrates a perspective view of one embodiment of the remote propane-monitoring device 100 of the present invention. The device 100 is comprised of a body 110 with a front surface 120 further comprised of a display 122 and at least one button 124, a retaining clip 170 and a mobile application 200 (shown in FIG. 4). The body 110 is preferably generally rectangular, but may be square, circular, triangular, etc., or any other suitable shape as is known in the art, in differing embodiments. The body 110 is also preferably manufactured from a rigid, water-resistant/water-proof, weather-resistant plastic material such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc., or any other suitable material as is known in the art. The body 110 has a front surface 120, a rear surface 130, a top surface 140, a bottom surface 150 and a pair of generally parallel side surfaces 160. The front surface 120 and/or rear surface 130 is further comprised of at least one display screen 122. In differing embodiments, the display screen 122 may be any display type known in the art such as, but not limited to, a touch screen, an LCD screen, an OLED screen, an ELD screen, an LED backlit LCD screen, an LED screen, a PDP screen, etc., or any other suitable display type as is known in the art. Further, any surface 120, 130, 140, 150, 160 of the body 110 may also comprise at least one (but preferably 3) button(s) 124, or any other suitable number of buttons 124 as is known in the art, whose purpose will be explained more fully below.

In order to power the display 122, the body 110 is further comprised of an internal battery 190 (shown in FIG. 4). The battery 190 may be a disposable battery or a rechargeable battery in the form of an alkaline, nickel-cadmium, nickel-metal hydride battery, etc., such as any 3V-12 volt DC battery or other conventional battery, such as A, AA, AAA, etc., that supplies power to the device 100. Throughout this specification the term “battery” may be used interchangeably to refer to one or more wet or dry cells or batteries of cells in which chemical energy is converted into electricity and used as a source of DC power. References to recharging or replacing the battery 190 may refer to recharging or replacing individual cells, individual batteries of cells or a package of multiple battery cells as is appropriate for any given battery technology that may be used. In addition, a rechargeable embodiment of the battery 190 may be recharged using a USB port 196 (shown in FIG. 4), wherein the USB port 196 is a USB-A, USB-B, Micro-B, Micro-USB, Mini-USB, or USB-C port, etc., or any other suitable port as is known in the art.

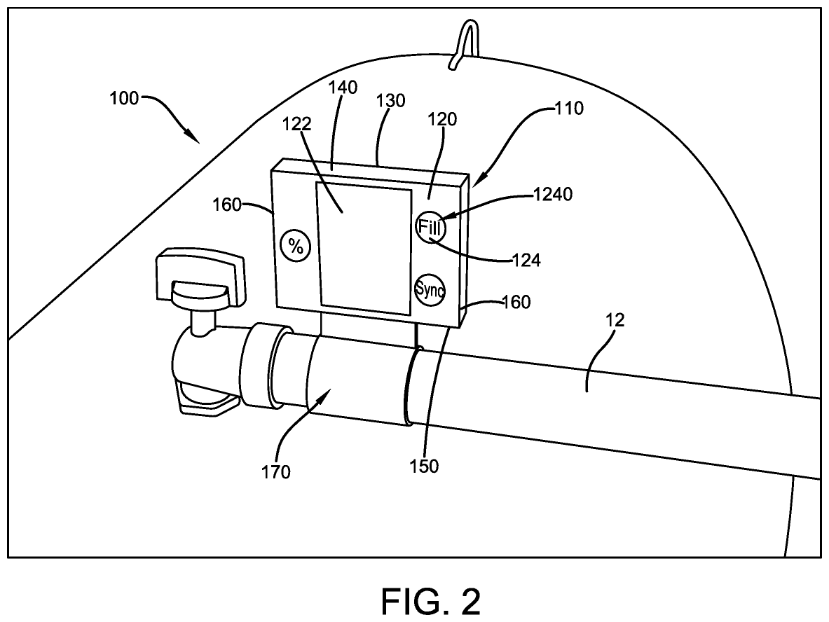

FIG. 2 illustrates a perspective view of one embodiment of the remote propane monitoring device of the present invention while attached to a small propane tank. As seen in FIG. 2 and FIG. 1, the body 110 may also comprise a hollow clip assembly 170, which is fixedly or removably-attached to the bottom surface 150 of the body 110 via a hollow vertical member 174, that extends away from the top of the clip body 172. In one embodiment, the clip assembly 170 has a generally circular, continuous body 172 with a continuous opening 1720 that allows the clip body 172 to be slid onto the piping/tubing 12 of a propane tank 10. It should be appreciated that in differing embodiments, the body 172 may be sized appropriately to fit around the piping/tubing 12 of differing sizes in differing sized propane tanks 10. For example, the body 172 may have at least one fastener 176 and a two-piece, generally circular body 172 that allows the body 172 to increase or decrease in size (i.e., diameter) in order to universally attach to any piping/tubing 12. In differing embodiments, the at least one fastener 176 may comprise fasteners such as, but not limited to, a screw, a set screw (i.e., similar to a hose clamp), a series of grooves on one half of the body 172 that can be received by a tongued edge of the other half of the body 172, a rachet mechanism, a clamp mechanism, a tying mechanism, etc., or any other suitable fasteners as is known in the art.

In another embodiment, the interior of the clip body 172 may have a plurality of male and/or female threads 1722, such that it can attach to an existing threaded end 32 of a propane gauge 30 of a propane tank 10 (i.e., where a piping/tubing 12 would normally be connected to the threaded end 32) and the piping/tubing 12 of the tank 10. In this manner, the clip 170 attaches to both the piping 12 and the pressure gauge 30, such that an internal pressure gauge 198 located within the body 110 and/or the vertical shaft 174 may read the pressure of the propane gas being pushed out from the tank 10, to determine the level of propane left in the tank 10 and relay said information to the mobile application 200.

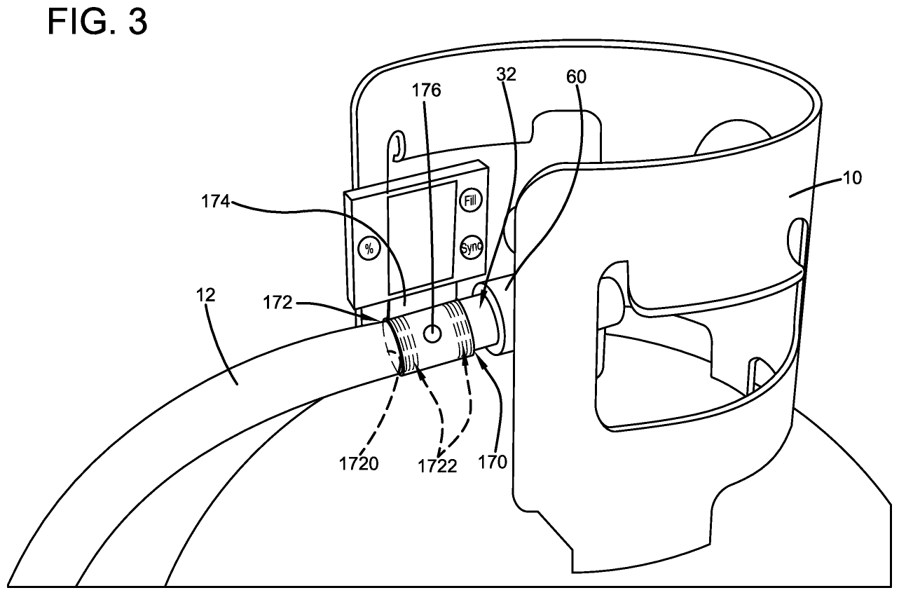

FIG. 3 illustrates a perspective view of one embodiment of the remote propane monitoring device 100 of the present invention while attached to a large propane tank. After being secured to piping/tubing 12 of a propane tank 10, the device 100 can remained attached to the tubing 12 during use. However, in the event that the propane tank 10 is located outdoors and in an area with inclement weather, the device 100 may also be comprised of a protective cover 180 that encloses the body 110 and clip 170. The cover 180 is preferably manufactured from the same material as the body 110 and has a water-repellant outer surface 182. The outer surface 182 may also have at least one continuous opening 184, that allows the piping 12 to exit the cover 180. In order to secure the cover 180 to a surface of a propane tank 10, the cover 180 may be comprised of at least one fastener 186 such as, but not limited to, hook and loop, snap-button, magnet, adhesive, button and loop, zipper assembly, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, an u-bolt, a lock nut, a castle nut, etc., or any other suitable fastener as is known in the art.

FIG. 4 illustrates a perspective view of one embodiment of the remote propane monitoring device 100 of the present invention. The device 100 is also comprised of a mobile application 200 that can be used on any smart device 20, to monitor the propane fuel status of at least one propane tank 10. The mobile application 200 presents the user with a visual representation 202 of the propane tank 10 the device 100 it is attached to, and the fuel status of said tank 10 (i.e., how much propane gas remains in the tank 10). In order to communicate with the mobile application 200, the device 100 comprises an integrated transmitter 192 that may communicate with the mobile application 200 via Wi-Fi, Bluetooth, Satellite, Cellular Data, etc. In addition, the device 100 is also comprised of a processor 194 that communicates with the PSI reading from the pressure gauge 198 and converts said reading into a percentage, representative of the amount of propane remaining in the tank 10. This percentage is then communicated to the transmitter 192 and is then sent to the mobile application 200 for viewing in the form of a visual representation 202. The mobile application 200 may also have at least one virtual representation of a button 204 that allows a user to access the same features provided by the physical buttons 124.

The at least one button 124 may further have a plurality of indica 1240 on its top surface, wherein the indica 1240 indicates the function of the button 124. In a preferred embodiment, the device 100 comprises at least 3 buttons 124, a first button that when pressed prompts the display 122 to display the remaining fuel percentage of the tank 10, a second button that can be used to alert a propane supplier (who can be selected using the mobile application 200) that the tank 10 needs to be refilled, and a third button that allows a user to pair the device 100 to a smart device 20 that has installed the mobile application 200.

The device 100 should and can be adapted to different monitoring types such as, but not limited to, use with a 201b BBQ type tank, the float gage for the 1,000 gal home or industrial tank, on a delivery truck to monitor propane from the office, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote propane monitoring device” and “device” are interchangeable and refer to the remote propane monitoring device 100 of the present invention.

Notwithstanding the forgoing, the remote propane monitoring device 100 of the present invention and its various components can be of any suitable size and configuration as is known in the art without affecting the overall concept of the invention, provided that they accomplish the above-stated objectives. One of ordinary skill in the art will appreciate that the size, configuration and material of the remote propane monitoring device 100 as shown in FIGS. 1-4 is for illustrative purposes only, and that many other sizes and shapes of the remote propane monitoring device 100 are well within the scope of the present disclosure. Although the dimensions of the remote propane monitoring device 100 are important design parameters for user convenience, the remote propane monitoring device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote propane monitoring device comprising:
a body comprising a front surface, a rear surface, a top surface, a bottom surface and a pair of opposing side surfaces, wherein the front surface comprises at least one display and at least one button;
an internal pressure gauge;
a battery; and
a mobile application.

2. The remote propane monitoring device of claim 1 further comprising a clip assembly, wherein the remote propane monitoring device is sized and configured to be attached to a propane tank.

3. The remote propane monitoring device of claim 2, wherein the internal pressure gauge measures a remaining fuel percentage of the propane tank.

4. The remote propane monitoring device of claim 3, wherein the remaining fuel percentage can be viewed by a user on the mobile application.

5. A remote propane monitoring device comprising:
a body comprising a front surface, a rear surface, a top surface, a bottom surface and a pair of opposing side surfaces, wherein the front surface comprises at least one display and at least one button;
a clip assembly that attaches to the rear surface;
a battery;
a transmitter;
a processor;
a USB port;
a cover that is sized and configured to be placed over the remote propane monitoring device while the remote propane monitoring device is attached to a propane tank;
an internal pressure gauge that reads a propane level of the propane tank that the remote propane monitoring device is attached to; and
a mobile application.

6. The remote propane monitoring device of claim 5, wherein the propane level detected by the internal pressure gauge can be viewed as a percentage on the mobile application.

7. The remote propane monitoring device of claim 5, wherein the mobile application allows a user to view the propane level detected by the internal pressure gauge of multiple remote propane monitoring devices located on a plurality of propane tanks.

8. A remote propane monitoring device comprising:
a body comprising a front surface, a rear surface, a top surface, a bottom surface and a pair of opposing side surfaces, wherein the front surface comprises at least one display and at least one button;
a hollow clip assembly that attaches to the rear surface, wherein the clip assembly is further comprised of a circular body that has a plurality of female threads on an interior surface of the circular body, which allow the remote propane monitoring device to be attached to a tubing of a propane tank and a propane gauge of the propane tank;
a battery;
a transmitter;
a processor;
a USB port;
a cover that can be placed over the remote propane monitoring device while the remote propane monitoring device is attached to the propane tank;
an internal pressure gauge that reads a propane level of the propane tank that the remote propane monitoring device is attached to; and
a mobile application that allows a user to view a visual representation of a propane level of the propane tank.

9. The remote propane monitoring device of claim 8, wherein the battery can be recharged via the USB port.

10. The remote propane monitoring device of claim 8, wherein the at least one button, when depressed, displays the propane level of the propane tank.

11. The remote propane monitoring device of claim 8, wherein the at least one button, when depressed, alerts a propane supplier that the propane tank that the remote propane monitoring device is attached to needs to be refilled.

12. The remote propane monitoring device of claim 8, wherein the at least one button, when depressed, pairs the remote propane monitoring device with a smart device that has the mobile application installed thereon.

13. The remote propane monitoring device of claim 8, wherein the mobile application presents the user with a visual representation of the propane tank and the propane level of the propane tank.

14. The remote propane monitoring device of claim 8, wherein the mobile application communicates with the transmitter via a Wi-Fi connection, a Bluetooth connection, a satellite connection or cellular connection.

15. The remote propane monitoring device of claim 8, wherein the processor communicates with the internal pressure gauge and receives a PSI reading from the internal pressure gauge.

16. The remote propane monitoring device of claim 15, wherein the mobile application converts the PSI reading into a percentage representative of the propane level in the propane tank.

17. The remote propane monitoring device of claim 8, wherein the at least one display is a touch screen, an LCD screen, an OLED screen, an ELD screen, an LED backlit LCD screen, an LED screen or a PDP screen.

18. The remote propane monitoring device of claim 8, wherein the hollow clip assembly is slid onto a tubing of the propane tank and fastened thereto with a fastener.

19. The remote propane monitoring device of claim 8, wherein the at least one button has a plurality of indica that indicates a plurality of functions of the at least one button.

20. The remote propane monitoring device of claim 8, wherein the plurality of indicia is located on a top surface of the at least one button.
